(19) United States
(12) Patent Application Publication
(10) Pub. No.: US 2011/0231400 A1
(43) Pub. Date: Sep. 22, 2011

(54) Method of Editing Document and Document Managerial System and Electronic Device Using the Same

(75) Inventors: Yi-Chen Sung, Taipei City (TW); Chien-Yuan Chen, Taipei City (TW); Fei Wu, Taipei City (TW)

(73) Assignee: Compal Electronics, Inc., Taipei City (TW)

(21) Appl. No.: 12/796,854

(22) Filed: Jun. 9, 2010

(30) Foreign Application Priority Data
Mar. 17, 2010 (TW) 99107856

(51) Int. Cl. G06F 17/30; G06F 3/14; G06F 17/00

(52) U.S. Cl. 707/738; 715/232; 715/234; 707/769; 707/E17.046; 707/E17.014

(57) ABSTRACT

Disclosed herein are a document manipulating method, a document managerial system, and an electronic device using the same. The electronic device includes the system, an activating unit, a determining unit and a placing unit. The system includes at least one label of a searchable and classifiable format, a database accessible by the electronic device, and a searching and classifying engine. The method includes the steps of activating a document, determining a labeling location and a labeling size within the document, placing the label at the labeling location to record a document description, and saving the label and a part of the document in the database.

### RELATED APPLICATIONS

This application claims priority to Taiwan Application Serial Number 99107856, filed Mar. 17, 2010, which is herein incorporated by reference.

### BACKGROUND

1. Technical Field

The present invention relates to a method of editing a document, a document managerial system and an electronic device comprising the same. More particularly, the present invention relates to a method of editing a document within an electronic device, a document managerial system using the method and the electronic device comprising the system for labeling documents.

2. Description of Related Art

With the advances of modern technology, computers are more commonly used in daily commercial activities and home entertainment, in addition to their conventional applications such as complex analyses, ammunition industry and industrial manufacture. Particularly, with the progress of semiconductor fabricating techniques, the computing ability of the computers leaps forward significantly, yet the size of a computer and the power consumption thereof becomes smaller and lesser. Consequently, the computers become indispensable devices in our daily lives.

People use computers to play music and videos, and to store all kinds of multimedia files, however, as the amount of stored files increases, it becomes essential for MIS personnel in business entities or for end users to manage these files effectively.

One common file managerial method is to separately place different types of files in different file folders, and these files are sorted by dates or filenames. When a massive amount of files are stored in the computer, the above-mentioned managerial method is inefficient in terms of file management. For example, by storing hundreds of photos in several file folders by dates, it is difficult for a user to find a specific photo. Further, it is even more difficult to find a specific file from a large number of files of various types.

Therefore, there exists a need for the industry to develop an easy and effective way to manage a massive amount of files.

### SUMMARY

An object of the invention is to provide a method of editing a document and a document managerial system and an electronic device using the method and system to solve the problems of document managerial inconvenience.

According to one aspect of the invention, a method of editing a document in an electronic device is provided. The method includes the steps of activating a document in an operating system of the electronic device; determining a labeling location and a labeling size within the document; placing at least one label at the labeling location in the document; recording a document description with the at least one label; and saving the at least one label and a part of the document corresponding to the labeling size in a database accessible by the electronic device. The at least one label is in a searchable and classifiable format.

In one embodiment of the invention, the method includes the steps of determining whether the document can be saved in the database or not; and when the document is determined unsavable in the database, capturing a screen snapshot of the part of the document corresponding to the labeling size.

In another embodiment of the invention, the step of saving the at least one label and the part of the document includes the step of saving the at least one label, the labeling location and the part of the document corresponding to the labeling size in the database located locally or remotely.

In a further embodiment of the invention, a labeled document is formed in the step of saving the at least one label and the part of the document, and the steps of the method are repeated several times to form several labeled documents. The method further includes the steps of determining a label attribute of the at least one label; and classifying the labeled documents in accordance with the label attribute.

In another embodiment of the invention, a labeled document is formed in the step of saving the at least one label and the part of the document, and the steps of the method are repeated several times to form several labeled documents. The method further includes the step of comparing a character string with several document descriptions of the labeled documents to acquire at least one of the labeled documents corresponding to the character string.

According to another aspect of the invention, a document managerial system is provided. The system includes at last one label, a database and a searching and classifying engine. The at least one label is in a searchable and classifiable format, and is used for placing at a labeling location in a document. The database is used for saving the at least one label and a part of the document corresponding to the labeling size. The searching and classifying engine is used for classifying and searching the document with the at least one label.

According to a further aspect of the invention, an electronic device is provided. The electronic device includes the above-described document managerial system; an activating unit for activating the document; a determining unit for determining the labeling location and the labeling size within the document; and a placing unit for placing the at least one label at the labeling location. The at least one label is used for recording a document description.

In the foregoing, by placing the at least one label in the document and recording the document description in the at least one label, the document can be searched and classified in a short time. The efficiency and the convenience of searching and managing the documents are improved.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a function diagram of an electronic device according to one embodiment of the invention;

FIG. 2 is a flow chart of a document manipulating method according to one embodiment of the invention;

FIG. 3A is a diagram of the document displayed on the screen;

FIG. 3B is a diagram of the label being placed in the document;

FIG. 3C is a diagram of the field for receiving the document description and the part of the document corresponding to the labeling size; and

FIG. 3D is a diagram of a labeled document.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

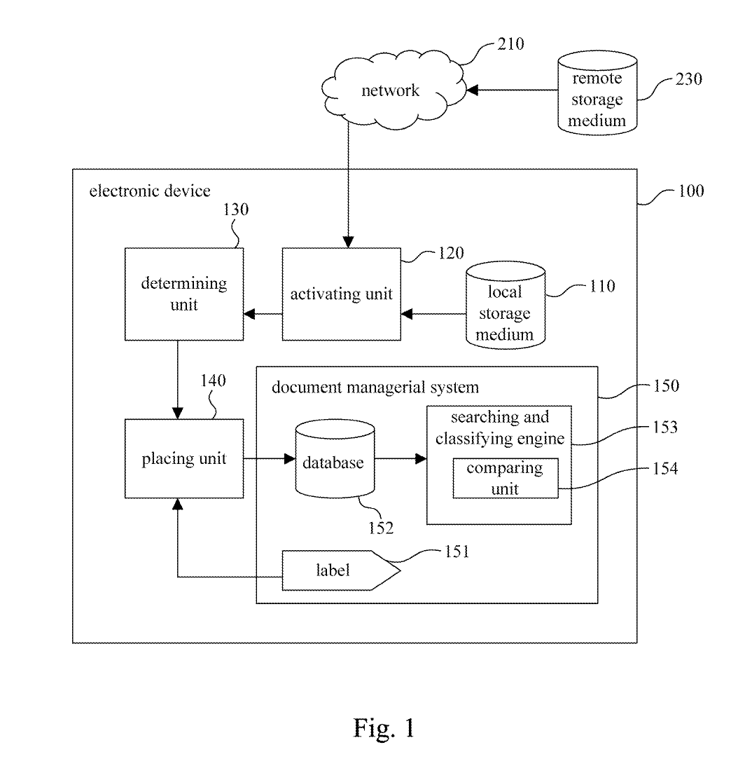

FIG. 1 is a function diagram of an electronic device according to one embodiment of the invention. The electronic device 100 of the present embodiment is exemplified by a personal computer. The electronic device 100 includes an activating unit 120, a determining unit 130, a placing unit 140 and a document managerial system 150. The document managerial system 150 includes at least one label 151, a database 152 and a searching and classifying engine 153.

The activating unit 120 is used for activating a document in the operating system of the electronic device 100. The document is stored in a local storage medium 110 of the electronic device 100, or, alternatively, stored in a remote storage medium 230 outside the electronic device 100. When the document is stored in the remote storage medium 230, the document can be accessed by the activating unit 120 via a network 210, such as a wide area network (WAN), a local area network (LAN) or Internet. Further, in the electronic device 100, the activating unit 120 is provided with numerous software modules and compilers corresponding to different file types, so the activating unit 120 can support numerous types of files, such as picture files, text files and hyper-text markup language (HTML) files. Upon activating a document, the content of the document is displayed on a screen of the electronic device 100, and is viewed by a user.

The determining unit 130 is used for determining a labeling location and a labeling size within the document. The labeling location is determined by the determining unit 130 in accordance with a cursor-clicking location, and the labeling size is determined by the determining unit 130 in accordance with a cursor-selecting size. Practically, the determining unit 130 may accept more than two cursor-clicking locations and more than two cursor-selecting sizes at the same time. The labeling size can either cover the entire document, or merely cover a part of the content of the document, depending on the selections made by the user.

The placing unit 140 is used for placing at least one label 151 onto the document. In one embodiment, one label 151 corresponds to one labeling location and one labeling size. In an alternative embodiment, a single labeling size can also correspond to multiple labels 151 at multiple labeling locations. The placing unit 140 further includes a visualizing module to provide an intuitive and graphic label 151, and to provide aesthetics and convenience for manipulating the label 151. The label 151 is used for recording a document description inputted by the user. When a number of labels 151 are placed in the document, the colors and the shapes of the labels 151 may be the same or different from each other.

The database 152 of the document managerial system 150 is used for saving at least one label 151 and the part of the document corresponding to the labeling size, thereby forming at least one labeled document. Practically, the database 152 is one that the electronic device 100 can get access to. For example, the database 152 is a local database disposed in the electronic device 100 as depicted in FIG. 1, yet in another embodiment, the database 152 is a remote database outside the electronic device 100. Generally, any database that is accessible by the electronic device 100 to save the label, the labeling location and the part of the document corresponding to the labeling size, can be used in the invention.

In the present embodiment, the database 152 is used for saving numerous labeled documents, so that the user can search among the labeled documents and classify these documents. In another embodiment that will be detailed in the below, the database 152 is used for saving the label, the labeling location and a screen snapshot when the document is covered by a protection mechanism and is therefore unable to be saved in the database 152. With the presence of the protection mechanism, the document managerial system 150 captures the screen snapshot of the part of the document corresponding to the labeling size.

The searching and classifying engine 153 of the document managerial system 150 is used for searching and classifying the documents with labels 151.

In one embodiment, the searching and classifying engine 153 includes a comparing unit 154 for comparing a character string with several document descriptions of labeled documents, so as to acquire at least one of the labeled documents corresponding to the character string. The user can therefore conduct searches among the labeled documents in the database 152. Practically, the character string, which is inputted by the user, may contain alphabet letters, numbers or foreign words (such as Chinese words and Japanese words), or the character string may be a combination of several logic conditions. Other known search techniques can be applicable to the electronic device 100 by using the comparing unit 154.

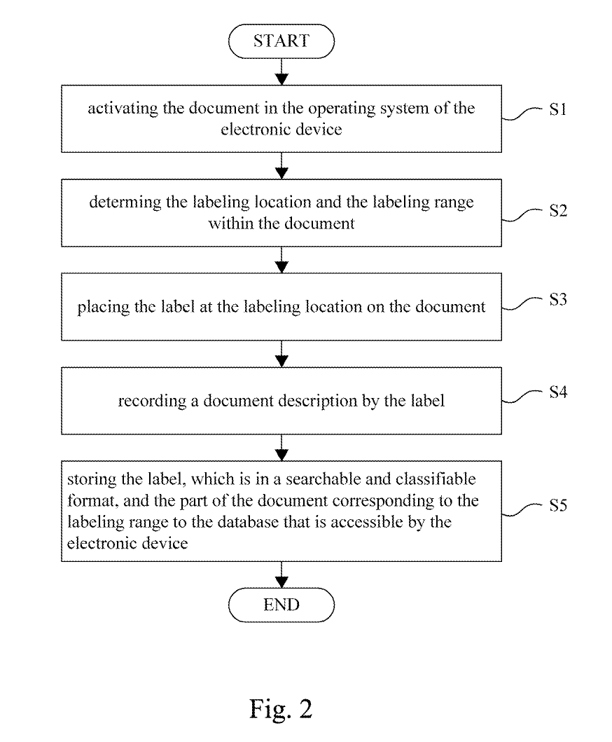

In the following description, a method for editing a document in an electronic device according to one embodiment of the invention is elaborated with referring to FIG. 1 and FIG. 2. FIG. 2 is a flow chart of a document manipulating method according to one embodiment of the invention. The aforementioned electronic device 100 (as depicted in FIG. 1) is taken as an example in the embodiment to simplify the description and to clearly show the characteristic of the invention.

First, step S1 is performed, activating the document in the operating system of the electronic device 100. In one embodiment, the document is stored in the local storage medium 110 and may be a picture file (with a filename extension as JPEG, TIFF, RAW or GIF), a text file (with a filename extension as TXT), or a hyper-text markup language file (with a filename extension as HTM or HTML). In practical use, a corresponding software module is used to activate the document, and the content of the document is displayed on a screen of the electronic device 100. Although the document is exemplified by storing in the local storage medium 110, the invention is not limited thereto. The document can be stored in the remote storage medium 230 and accessed via the network 210 in another embodiment.

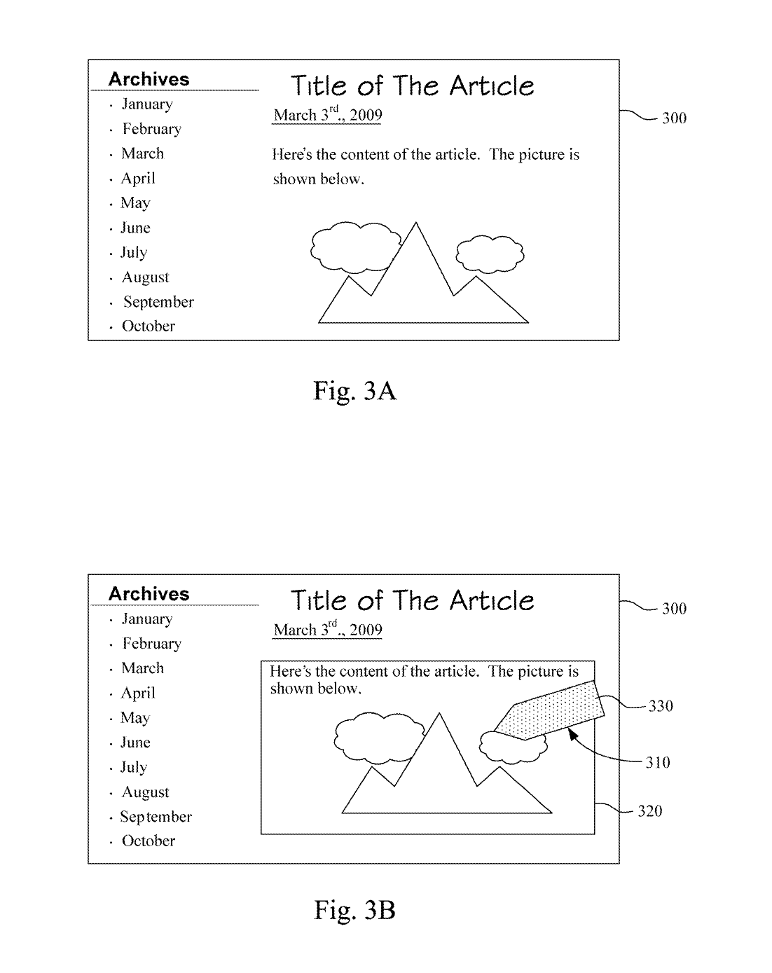

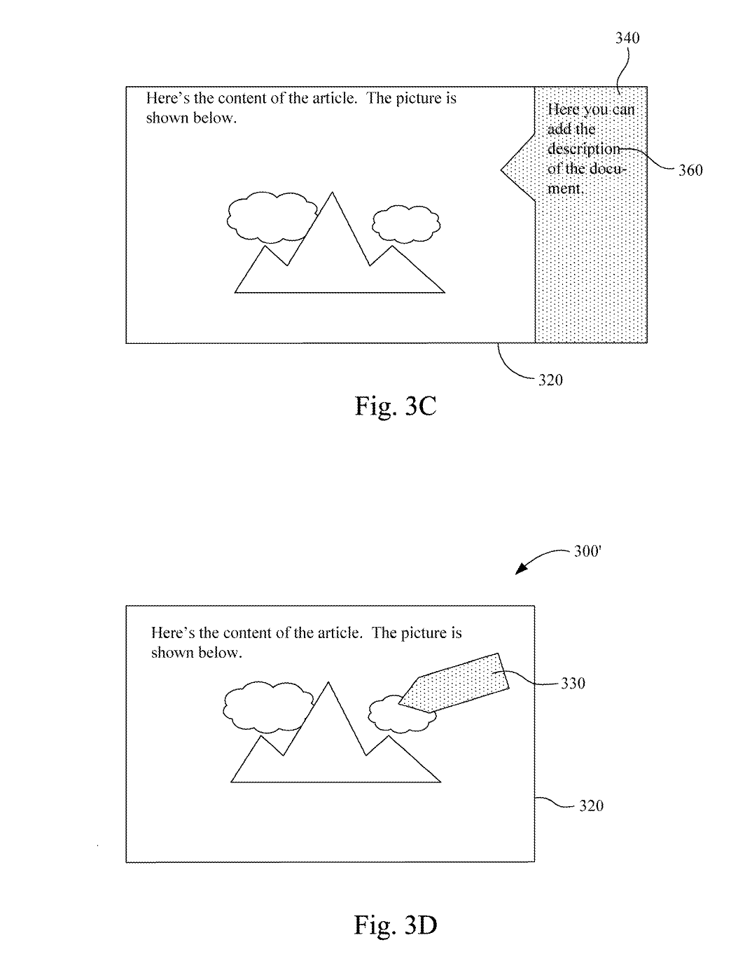

FIG. 3A is a diagram of the document displayed on the screen. The document 300 is exemplified by an HTML file and its content of texts and pictures is displayed on the screen. In certain cases, a frame of the screen is not wide and/or long enough to show the entire content at one time; that is, the content of the document 300 is partially shown on the screen. Therefore the user may zoom in/out and scroll the document 300 to change the part of the content being shown on the screen.

Next, the method proceeds to step S2 and step S3. The labeling location and the labeling size are determined within the document 300, and at least one label 151 is placed onto the document 300. FIG. 3B is a diagram of the label being placed in the document. The user may determine the cursor-clicking location and the cursor-selecting size by utilizing a keyboard, a mouse, a graphic tablet, a touch screen or other input devices, so the labeling size 320 and the labeling location 310 for placing the label 151 can be determined. After the labeling size 320 and the labeling location 310 are determined, a graphic label 330 is placed at the labeling location 310 in the document 300.

Practically, one or more labeling locations 310 and one or more labeling sizes 320 can be determined in step S2, and one or more graphic labels 330 can be placed in step S3 accordingly. The labeling size 320 of the present embodiment may either cover only a part of the document 300 or cover the entire content of the document 300, depending on actual needs. Moreover, the method may optionally include a step of determining the attributes of the label 151, where the color or the shape of the label 151 can be selected by the user. For example, the selectable colors and shapes of the graphic label 330 that the user may choose from are shown on the screen, which facilitates the subsequent classifying and sorting of several labels 151.

Then, the method proceeds to step S4, recording the document description in the label 151. FIG. 3C is a diagram of the field for receiving the document description and the document corresponding to the labeling size. In one practical manner, when the graphic label 330 on the screen is clicked, a description receiving field 340 is displayed on the screen, more specifically, next to the labeling size 320 as depicted in FIG. 3C. The description receiving field 340 matches the label 151 and is used for receiving inputted document descriptions 360 from the user. What is inputted in the description receiving field 340 is saved and kept in the label 151.

Afterwards, the method proceeds to step S5, saving the label 151 and the part of the document 300 corresponding to the labeling size 320 in the database 152. The saved label 151 and corresponding document 300 therefore form the labeled document 300′, as shown in FIG. 3D. FIG. 3D is a diagram of a labeled document. Practically, in step S5, the graphic label 330, the labeling location 310 and the part of the document 300 corresponding to the labeling size 320 are saved in the local database 152 of the electronic device 100.

In certain circumstances, the document 300 may not be allowed to be stored into the database 152 for the reason of a copyright protection or other protection mechanisms. For example, the web pages located in the remote storage medium 230 cannot be saved to the local database 152. Therefore, the document manipulating method may further include a determining step prior to step S5 to determine whether the document 300 is able to be saved in the database 152 of the document managerial system 150 or not. When the document 300 is determined to be the one that can be saved to the database 152, the graphic label 330, the labeling location 310 and the part of the document 300 corresponding to the labeling size 320 are saved in the database 152. Otherwise, the screen snapshot of the part of the document 300 corresponding to the labeling size 320 is captured, and the graphic label 330, the labeling location 310 and the screen snapshot is saved in the database 152 to form the labeled document 300′.

In the present embodiment, the above-described steps S1 through S5 are repeated several times, so as to form several labeled documents. These labeled documents may respectively have different numbers of labels with different colors and shapes. In this manner, the labeled documents can be classified and sorted in accordance with the attributes of the labels.

Moreover, the method may optionally include a search step. By comparing the character string with the document descriptions of the labeled documents, at least one of the labeled documents corresponding to the character string can be acquired. The character string may contain alphabet letters, numbers or foreign words (such as Chinese words and Japanese words), or the character string may be a combination of several logic conditions. In the document manipulating method of the present embodiment, the search results can be promptly acquired by searching the document descriptions and/or the contents of the documents.

In the above described method, the document managerial system and the electronic device using the same, the contents of several different types of documents can be labeled by placing at least one label on each document, and the labels are used for saving the document descriptions. The labeled documents can be classified and sorted in accordance with the attributes of the labels, and the user may conduct searches and comparisons among the labeled documents, so as to increase the convenience and the efficiency of managing the documents.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method of editing a document in an electronic device comprising:
(a) activating a document in an operating system of the electronic device;
(b) determining a labeling location and a labeling size within the document;
(c) placing at least one label at the labeling location in the document;
(d) recording a document description with the at least one label; and
(e) saving the at least one label and a part of the document corresponding to the labeling size in a database that is accessible by the electronic device, wherein the at least one label is in a searchable and classifiable format.

2. The method of claim 1, wherein the step (a) comprises:
activating the document stored in a local storage medium of the electronic device; and
displaying the content of the document on a screen of the electronic device.

3. The method of claim 2, wherein the document is a picture file, a text file or a hyper-text markup language (HTML) file.

4. The method of claim 2, wherein the labeling size covers at least a part of the content of the document.

5. The method of claim 1, wherein the step (a) comprises:
activating the document stored in a remote storage medium through a network; and
displaying the content of the document on a screen of the electronic device.

6. The method of claim 5, wherein the document is a picture file, a text file or a HTML file.

7. The method of claim 5, wherein the labeling size covers at least a part of the content of the document.

8. The method of claim 1, further comprising:
determining whether the document can be saved in the database or not;
when the document is determined to be unsavable in the database, capturing a screen snapshot of the part of the document corresponding to the labeling size.

9. The method of claim 8, wherein the step (e) comprises:
saving the at least one label, the labeling location and the screen snapshot in the database.

10. The method of claim 1, wherein in the step (b), the labeling location is determined by a cursor-clicking location and the labeling size is determined by a cursor-selecting size.

11. The method of claim 1, wherein the step (e) comprises:
saving the at least one label, the labeling location and the part of the document corresponding to the labeling size in the database located locally or remotely.

12. The method of claim 1, further comprising:
determining a label attribute of the at least one label.

13. The method of claim 12, wherein the label attribute comprises the color and the shape of the at least one label.

14. The method of claim 12, wherein in the step (e), a labeled document is formed by saving the at least one label and the part of the document corresponding to the labeling size, and the steps (a) to (e) are performed repeatedly to form a plurality of the labeled documents, and the method further comprises:
classifying the labeled documents in accordance with the label attribute.

15. The method of claim 1, wherein in the step (e), a labeled document is formed by saving the at least one label and the part of the document corresponding to the labeling size, and the steps (a) to (e) are performed repeatedly to form a plurality of the labeled documents, and the method further comprises:
comparing a character string with a plurality of the document descriptions of the labeled documents to acquire at least one of the labeled documents corresponding to the character string.

16. A document managerial system, comprising:
at least one label for placing at a labeling location of a document, wherein the at least one label is in a searchable and classifiable format, and the document has a labeling size;
a database for saving the at least one label and a part of the document corresponding to the labeling size; and
a searching and classifying engine for classifying and searching the document with the at least one label.

17. An electronic device, comprising:
the document managerial system of claim 16;
an activating unit for activating the document in an operating system of the electronic device;
a determining unit for determining the labeling location and the labeling size within the document; and
a placing unit for placing the label at the labeling location of the document, wherein the label is used for recording a document description.

18. The electronic device of claim 17, wherein the database is used for saving the at least one label, the labeling location and a screen snapshot of the part of the document corresponding to the labeling size.

19. The electronic device of claim 17, wherein a labeled document is formed by saving the at least one label and the part of the document corresponding to the labeling size, and a plurality of the labeled documents are saved in the database, and the classifying and searching engine comprises:
a comparing unit for comparing a character string with a plurality of document descriptions of the labeled documents to acquire at least one of the labeled documents corresponding to the character string.
